(19) United States
(12) Patent Application Publication
(10) Pub. No.: US 2010/0312673 A1
(43) Pub. Date: Dec. 9, 2010

(54) Method of managing and insuring inventories of products needed for emergency management during and/or after natural disasters and emergencies

(76) Inventor: Nevin M. Sendel, Ontario (CA)

Correspondence Address: NIXON & VANDERHYE, PC, 901 NORTH GLEBE ROAD, 11TH FLOOR, ARLINGTON, VA, 22203, US

(21) Appl. No.: 12/801,340

(22) Filed: Jun. 3, 2010

Related U.S. Application Data
(60) Provisional application No. 61/213,384, filed on Jun. 3, 2009.

(51) Int. Cl. G06Q 10/00

(52) U.S. Cl. 705/28

(57) ABSTRACT

A method of managing inventory of products needed by a governing body during a natural disaster or emergency, comprising maintaining an inventory of the products, which may be perishable or non-perishable, for use by the governing body, insuring the inventory of the products against the result that no natural disaster or emergency will occur during a specified time period, receiving payment from the governing body for all products in inventory used during the specified time period in connection with a natural disaster or emergency, and receiving payment from an insurer for all products in inventory not used during the specified time period.

### CROSS-REFERENCES TO RELATED APPLICATIONS

This application claims the priority of Provisional Patent Application No. 61/213,384 filed on Jun. 3, 2009.

### BACKGROUND OF THE INVENTION

1. Field of the Invention

The present invention relates to a method of maintaining inventories of products needed for emergency management and, more particularly, to a method of insuring that the supplier of such products will be paid the selling price of all such products in inventory whether or not a natural disaster or emergency occurs during a specified period, e.g., the shelf life of the products.

2. Description of the Background Art

Because of an uncertain and unpredictable demand, suppliers of food products and other products have difficulty in building and maintaining sufficient inventories of such products to meet the immediate demand that invariably occurs when a natural disaster or emergency strikes an area of the United States or another country. For example, self heating meals are highly in demand by national and state bodies whenever a disaster strikes or an emergency occurs, and displaced citizens require immediate nourishment. Such products have a limited shelf life and thus would be completely lost to a supplier maintaining a significant inventory of such products if no disaster or emergency occurred during the shelf life period.

Accordingly, a need has arisen for an effective method of insuring that sufficient inventories of products needed for emergency management will be available when a natural disaster strikes or an emergency occurs.

### BRIEF SUMMARY OF THE INVENTION

In accordance with the method of the present invention, an underwriter is located, e.g., online with the use of a computer or the like, that would be willing to insure against the result of no natural disaster or emergency of a specified category occurring over a specified period of time, e.g., the shelf life of self heating meals maintained in inventory by a supplier which may be three years or the like. The supplier would insure the value of the inventory at the selling price to insure that it would be paid whether or not a natural disaster or emergency occurred during the specified period.

Thereafter, governing bodies such as state and national governments would be contacted, e.g., online with the use of a computer or the like, to request tenders by suppliers willing to make and store inventory on consignment for the governing bodies which would only pay for inventory such as self heating meals used during or after a natural disaster or emergency. In this manner, the suppliers maintaining inventory of products for emergency management on consignment for the governing bodies would be paid for the inventory used by the governing bodies and would also be paid for the inventory not used over a specified period of time by an underwriter insuring against the result of no natural disaster or emergency occurring during the specified time period, such as the shelf life of perishable products or the like. In order to maintain a sufficient inventory of products for emergency management on consignment for governing bodies, suppliers could obtain the necessary funds from investors who would secure their investments as bond holders, shareholders or the like. Such investors could be solicited online with the use of a computer or the like.

### BRIEF DESCRIPTION OF THE DRAWINGS

FIG. 1 is a block diagram illustrating the steps in the method of the present invention.

### DETAILED DESCRIPTION OF THE INVENTION

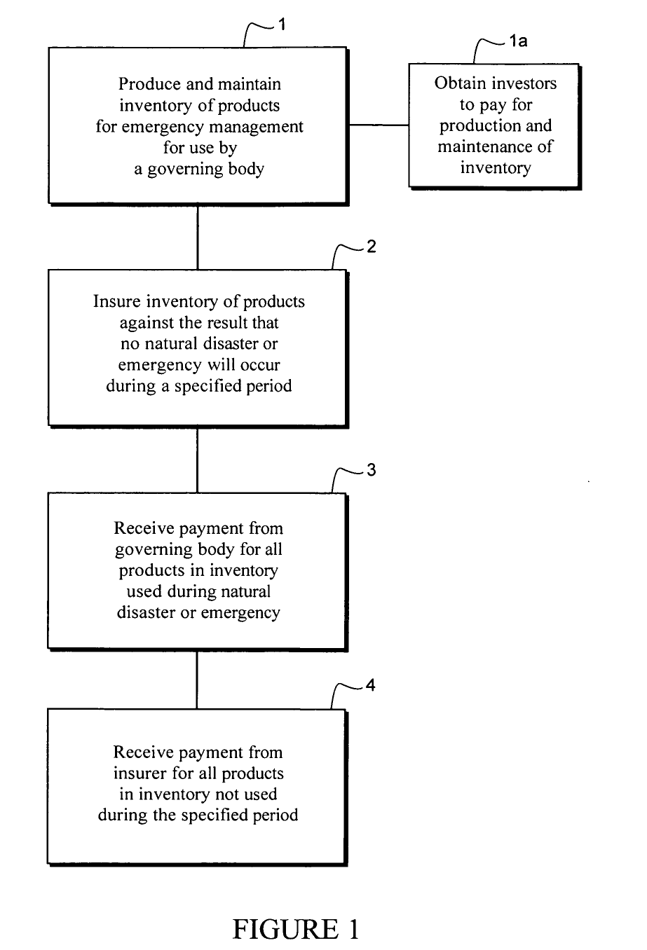

Referring to FIG. 1 and as hereinbefore described, the method of the present invention comprises the following steps:
1. Producing and maintaining an inventory of products for emergency management, such as self heating meals, for use by a governing body (Block 1);
2. Optionally, obtaining investors to pay for the production and maintenance of the inventory of products for emergency management (Block 1a);
3. Insuring the inventory of products for emergency management against the result that no natural disaster or emergency will occur during a specified period, e.g., the shelf life of a perishable product such as a self heating meal (Block 2);
4. Receiving payment from the governing body for all products in inventory used during or after a natural disaster or emergency (Block 3); and
5. Receiving payment from an insurer for all products in inventory not used during the specified period, such as the shelf life of the products (Block 4).

In this manner, a supplier who produces and/or maintains the inventory of the products for emergency management can be assured that it will receive the selling price of the products during the specified time period, which may be the shelf life of the products, whether or not a natural disaster or emergency occurs during the specified time period. By providing this incentive to the supplier of such products, the governing body can be assured that sufficient products for emergency management will be available upon the occurrence of a natural disaster or emergency. Also, the governing body would only have to pay for the products in inventory actually used during or after the natural disaster or emergency.

The method of the present invention could be used with any types of products necessary for emergency management, whether perishable or non-perishable, such as food, water, equipment and the like. In the case of perishable products, the specified period of insurance may be the shelf life of the product. In the case of non-perishable products, the specified insurance period may be a fixed time period agreed to between the insurer and the supplier.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A method of managing inventory of products needed by a governing body during a natural disaster or emergency, comprising:
maintaining an inventory of the products for use by the governing body;
insuring the inventory of the products against the result that no natural disaster or emergency will occur during a specified time period;
receiving payment from the governing body for all products in inventory used during the specified time period in connection with a natural disaster or emergency; and
receiving payment from an insurer for all products in inventory not used during the specified time period.

2. The method of claim 1 wherein the products are produced by a supplier who maintains the inventory.

3. The method of claim 2 wherein investors provide funds to the supplier to produce and maintain the inventory of the products.

4. The method of claim 1 wherein the products have a limited shelf life and the specified time period is an estimated shelf life of the products.

5. The method of claim 4 wherein the products are food products.

6. The method of claim 5 wherein the products are self heating meals.

7. The method of claim 1 wherein the payment received from the governing body and from the insurer is a selling price of the products.
